(19) United States
(12) Patent Application Publication
(10) Pub. No.: US 2012/0289401 A1
(43) Pub. Date: Nov. 15, 2012

(54) METHOD FOR PRODUCING NANOPARTICLES

(75) Inventor: Hideki TANAKA, Chino-shi (JP)

(73) Assignee: SEIKO EPSON CORPORATION, Tokyo (JP)

(21) Appl. No.: 13/461,279

(22) Filed: May 1, 2012

(30) Foreign Application Priority Data
May 12, 2011 (JP) 2011-106982

(51) Int. Cl. B01J 23/52; C09K 3/00; B82Y 40/00

(52) U.S. Cl. 502/344; 252/182.33; 977/840; 977/900

(57) ABSTRACT

A method for producing nanoparticles includes: producing a nanoparticle dispersion ion gel in which a plurality of nanoparticles are dispersed; and dissolving the nanoparticle dispersion ion gel, thereby producing a liquid in which the plurality of nanoparticles are dispersed.

### BACKGROUND

1. Technical Field

The present invention concerns nanoparticles and relates to, for example, a substance containing nanoparticles and having properties exhibited by the presence of the nanoparticles, and a method for producing a substance having the properties.

2. Related Art

Metal or semiconductor nanoparticles having a diameter of several nanometers to several tens nanometers exhibit optical electrochemical properties depending on the size unlike a bulk material. Therefore, such nanoparticles are expected to be applied to the fields of biosensing, catalysts, optics, electrochemistry, etc. For example, it is known that when gold which is catalytically inactive in the case of a bulk material is formed into nanoparticles, the gold nanoparticles act as a highly active catalyst, and the synthesis of nanoparticles is an important technique in the catalyst field.

Metal nanoparticles have been produced so far by a liquid-phase chemical reduction method (wet process) in which a metal ion or a metal complex is chemically reduced in a solution in many cases. For example, a wet process for producing nanoparticles in a solution using a chemical reaction is described in JP-A-2005-281781. In such a process, a stabilizing agent such as a thiol or a polymer is added so as to prevent aggregation of particles, and therefore, it is possible to produce metal nanoparticles having a relatively uniform particle diameter.

On the other hand, as another method for producing metal nanoparticles, a dry process such as a vacuum vapor deposition method described in JP-A-9-256140 is used. In this case, in the early stage of the deposition of a metal, nanoparticles having a uniform size are formed on a solid substrate. With this process, few byproducts are generated, and moreover, metal nanoparticles having a clean particle surface without adsorbing a stabilizing agent or the like can be produced.

However, such a wet process and a dry process in the related art have the following problems. First, in the wet process, although a large amount of nanoparticles having a relatively uniform particle diameter can be produced, the obtained nanoparticles are liable to aggregate in a solution. Therefore, in order to obtain favorable dispersion stability in a solution, it is necessary to chemically modify the surfaces of the particles with a stabilizing agent such as a surfactant. Therefore, the obtained nanoparticles are not suitable for use as a highly active catalyst or the like in which the surfaces of the particles are used as active sites. Further, in a reaction solution, a byproduct, a substrate, a stabilizing agent, and the like remain as impurities. In order to apply the nanoparticles as a catalyst or the like, the contamination with such impurities is not favorable, and it is sometimes necessary to purify the obtained metal nanoparticles. Subsequently, in the dry process, the surfaces of the nanoparticles are not chemically modified, and pure nanoparticles can be produced in a relatively simple system, however, the obtained nanoparticles have a broad particle size distribution, and it is difficult to obtain nanoparticles having a uniform particle diameter. Further, the production amount relative to the using amount of starting materials is small, and the production cost is increased. In addition, the dry process generally has a disadvantage that as the deposition time increases, the particle size of each particle increases, and the nanoparticles become bulky or turn into a thin film. Further, the dry process includes vapor deposition on a solid substrate, and therefore, it is difficult to produce a large amount of monodisperse metal nanoparticles. In terms of the properties of the thus obtained nanoparticles, the productivity thereof, and the like, a novel production method which is superior to the wet process and the dry process in the related art has been demanded.

### SUMMARY

An advantage of some aspects of the invention is to solve at least a part of the problems described above and the invention can be implemented as the following forms or application examples.

### Application Example 1

This application example of the invention is directed to a method for producing nanoparticles which includes: producing a nanoparticle dispersion ion gel in which a plurality of nanoparticles are dispersed in an ion gel; and dissolving the nanoparticle dispersion ion gel, thereby producing a liquid in which the plurality of nanoparticles are dispersed.

According to this method, the nanoparticle dispersion ion gel can be dissolved in a liquid by heating, sonication, and stirring, and therefore, the nanoparticle dispersion ion gel can be easily dissolved.

### Application Example 2

This application example of the invention is directed to the method for producing nanoparticles of the above application example, which further includes centrifuging the liquid in which the plurality of nanoparticles are dispersed.

According to this method, by centrifuging the liquid in which the nanoparticle dispersion ion gel is dissolved, the nanoparticles can be easily isolated.

### Application Example 3

This application example of the invention is directed to the method for producing nanoparticles according to the above application example, wherein the producing a nanoparticle dispersion ion gel includes evaporating an evaporation source containing an element contained in the nanoparticles toward the ion gel under reduced pressure in a vapor deposition apparatus.

According to this method, the plurality of nanoparticles can be easily dispersed in the ion gel using a vapor deposition apparatus in which the internal air pressure is reduced from the atmospheric pressure. Further, since a vapor deposition object is the ion gel, the degree of freedom of the positional relation between the evaporation source (sometimes also referred to as “target”) and the vapor deposition object in the vapor deposition apparatus is high, and therefore, the range of the apparatus which can be used can be increased. For example, a vapor deposition apparatus in which the vapor deposition object is disposed at a higher position than the evaporation source can be also used. As the vapor deposition apparatus, a general sputtering vapor deposition apparatus, resistance heating vapor deposition apparatus, or the like may be used. In the following embodiments, the evaporation source is sometimes referred to as “nanoparticle precursor”.

### Application Example 4

This application example of the invention is directed to the method for producing nanoparticles according to the above application example, wherein the producing a nanoparticle dispersion ion gel includes: stirring a mixed liquid containing an ionic liquid and a gelling agent; and drying the stirred mixed liquid.

According to this method, the production of the ion gel can be performed by stirring a mixed liquid containing an ionic liquid and a gelling agent, followed by drying, and therefore, the ion gel can be easily produced.

### BRIEF DESCRIPTION OF THE DRAWINGS

The invention will be described with reference to the accompanying drawings, wherein like numbers reference like elements.

FIGS. 1A and 1B are a flow chart showing a method for producing nanoparticles according to an embodiment.

FIG. 2 is an imaginary view when a sputtering vapor deposition apparatus according to an embodiment is used.

FIG. 3 is a photograph of an ion gel according to an embodiment.

FIG. 4 is a photograph of a nanoparticle dispersion ion gel according to an embodiment.

FIG. 5 is a photograph of an interior of a nanoparticle dispersion ion gel using a transmission electron microscope according to an embodiment.

FIG. 6 is a photograph of a nanoparticle using a transmission electron microscope according to an embodiment.

FIG. 7 is a photograph of diffraction light of a nanoparticle dispersion ion gel using a transmission electron microscope according to an embodiment.

FIG. 8 is a view of an optical absorption spectrum of a nanoparticle dispersion ion gel according to an embodiment.

FIG. 9 is an imaginary view when a resistance heating vapor deposition apparatus according to an embodiment is used.

FIG. 10 is a photograph of a solution in which a nanoparticle dispersion ion gel according to an embodiment is dissolved or dispersed.

FIG. 11 is a view of an optical absorption spectrum of a solution in which a nanoparticle dispersion ion gel according to an embodiment is dissolved or dispersed.

### DESCRIPTION OF EXEMPLARY EMBODIMENTS

Hereinafter, embodiments of the invention will be described with reference to the accompanying drawings.

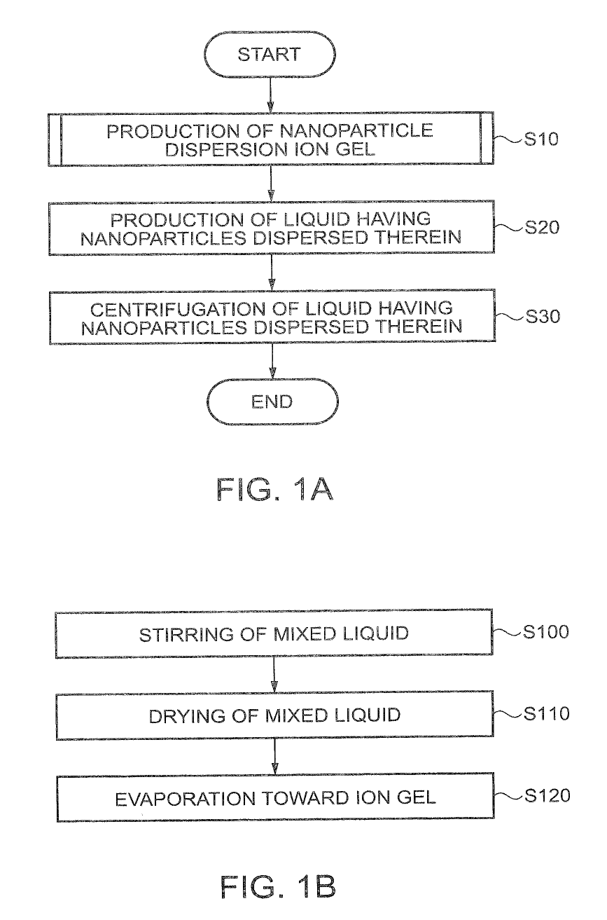

FIGS. 1A and 1B are a flow chart showing a method for producing nanoparticles according to this embodiment. As shown in FIG. 1A, the method for producing nanoparticles according to this embodiment includes: a step of producing a nanoparticle dispersion ion gel in which a plurality of nanoparticles are dispersed in an ion gel shown in Step S10; a step of dissolving the nanoparticle dispersion ion gel, thereby producing a liquid in which the plurality of nanoparticles are dispersed shown in Step S20; and a step of centrifuging the liquid in which the plurality of nanoparticles are dispersed shown in Step S30.

Further, as shown in FIG. 1B, the step of producing a nanoparticle dispersion ion gel (Step S10) includes: a step of stirring a mixed liquid containing an ionic liquid and a gelling agent shown in Step S100; a step of drying the stirred mixed liquid, thereby producing an ion gel shown in Step S110; and a step of evaporating an evaporation source containing an element contained in the nanoparticles toward the ion gel under reduced pressure in a vapor deposition apparatus shown in Step S120.

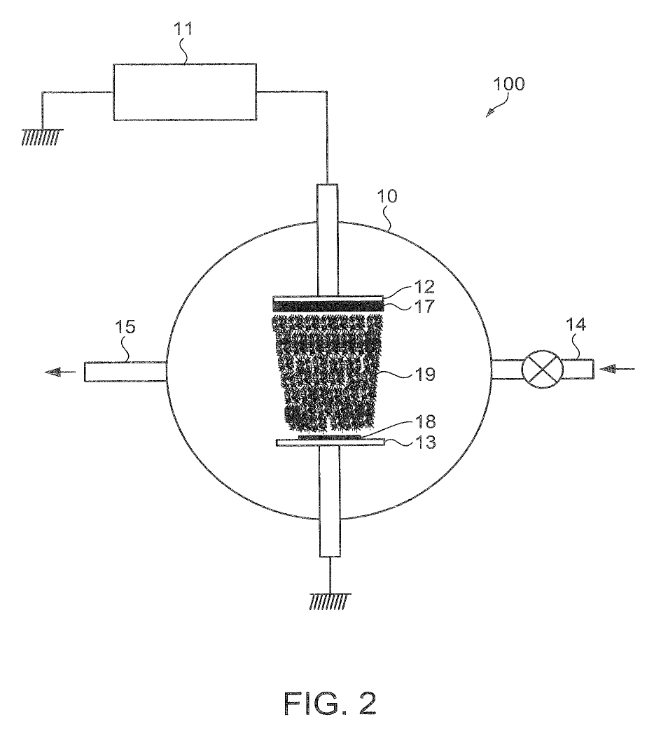

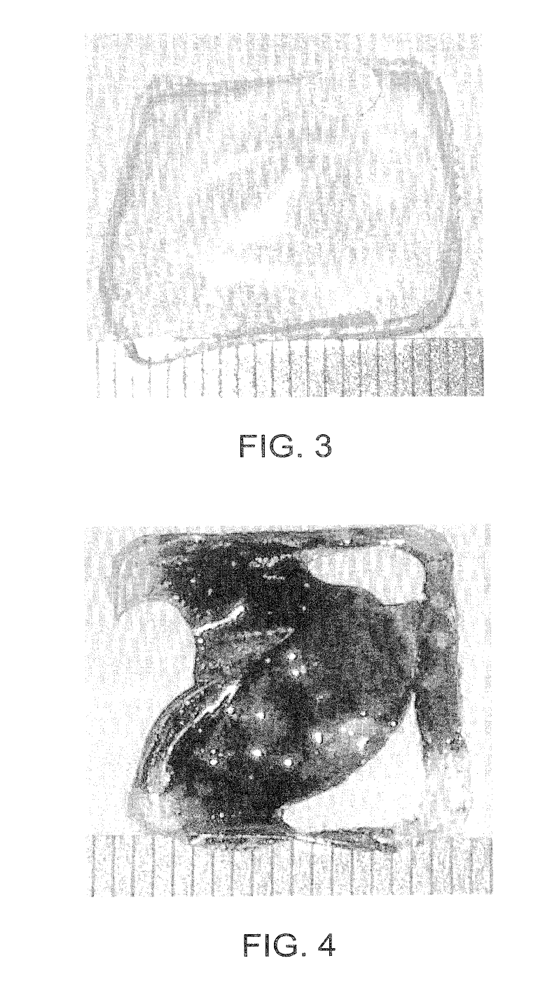

FIG. 2 is an imaginary view when a sputtering vapor deposition apparatus according to this embodiment is used, FIG. 3 is a photograph of the ion gel according to this embodiment, and FIG. 4 is a photograph of the nanoparticle dispersion ion gel according to this embodiment.

By subjecting the ion gel produced as described below to sputtering, the nanoparticle dispersion ion gel was formed.

### Production of Ion Gel

As materials, an ionic liquid, a gelling agent, and organic solvents shown below were used.

Ionic liquid: 1-ethyl-3-methylimidazolium tetrafluoroborate (EMIBF₄)

Gelling agent: poly(vinylidene fluoride-hexafluoropropylene) (PVdF-HFP)

Organic solvent (1): propylene carbonate

Organic solvent (2): methyl pentanone

100 mg of the ionic liquid and 100 mg of the gelling agent are mixed. The resulting mixture is dissolved in a mixed liquid containing 360 mg of the organic solvent (1) and 1 ml of the organic solvent (2), and the resulting mixed liquid is stirred at 80° C. for 5 hours. Thereafter, the stirred mixed liquid is dried, whereby an ion gel is produced. A photograph of the thus produced ion gel is shown in FIG. 3.

### First Embodiment of Dispersion of Nanoparticles in Ion Gel

The above ion gel was placed in a sputtering vapor deposition apparatus (JFC-1500, manufactured by JEOL Ltd.), and a gold plate as a target material (nanoparticle precursor) was set therein, and gold sputtering was performed for 5 minutes. A photograph of the thus produced nanoparticle dispersion ion gel is shown in FIG. 4.

An imaginary view according to this embodiment is shown in FIG. 2. In FIG. 2, a sputtering vapor deposition apparatus 100 is shown. The sputtering vapor deposition apparatus 100 has a sample treatment chamber 10, and in the sample treatment chamber 10, a cathode 12 is disposed in an upper portion thereof and an anode 13 is disposed in a lower portion thereof. To the cathode 12, a high-voltage section 11 is connected. Further, in order to reduce pressure in the sample treatment chamber 10, a vacuum pump (not shown) is attached to an exhaust pipe 15. In addition, a feed pipe 14 for feeding Ar gas or the like is provided.

A nanoparticle precursor 17 is attached to the cathode 12, and an ion gel 18 is placed on the anode 13. In this embodiment, the nanoparticle precursor 17 is a gold plate. When a high voltage is applied to the cathode 12 in this state, gold atoms are ejected from the nanoparticle precursor 17 to form a discharge plasma region 19. Then, the gold atoms penetrate into the ion gel 18 to form nanoparticles, which are maintained there. In this manner, the nanoparticle dispersion ion gel is produced.

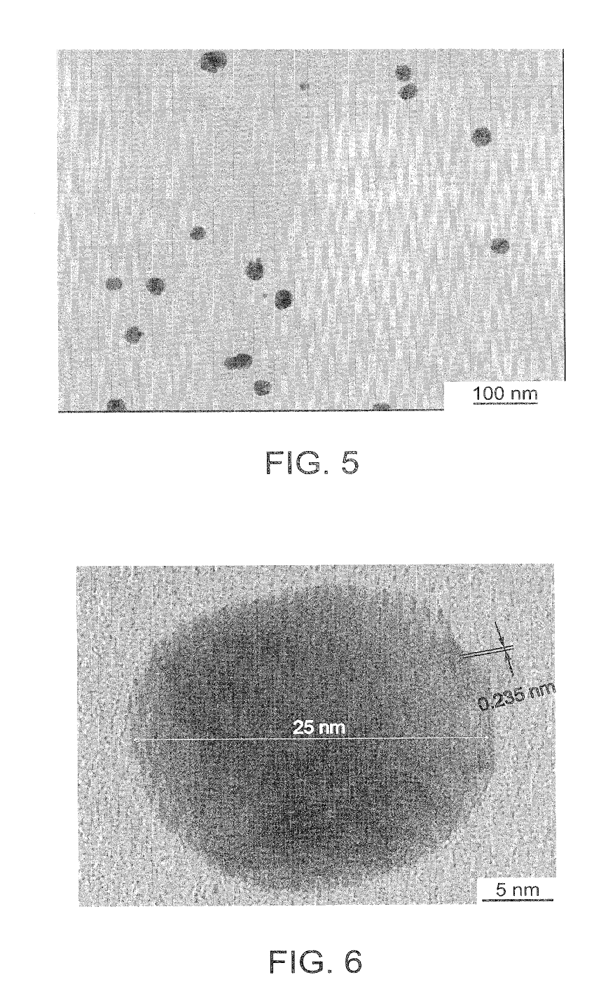

Transmission electron micrographs of the thus produced nanoparticle dispersion ion gel are shown in FIGS. 5 to 7.

FIG. 5 is a photograph of an interior of the nanoparticle dispersion ion gel using a transmission electron microscope according to this embodiment and shows an image of the ion gel and gold nanoparticles dispersed in the ion gel. The particles that have a black appearance are the gold nanoparticles. FIG. 6 is a photograph of the nanoparticles using a transmission electron microscope according to this embodiment and shows a high-resolution transmission electron micrograph of a single nanoparticle. The particle diameter of the nanoparticle shown in FIG. 6 is about 25 nm, and lattice fringes attributed to an interplanar spacing of 0.235 nm in the (111) plane of the fcc structure of gold are observed.

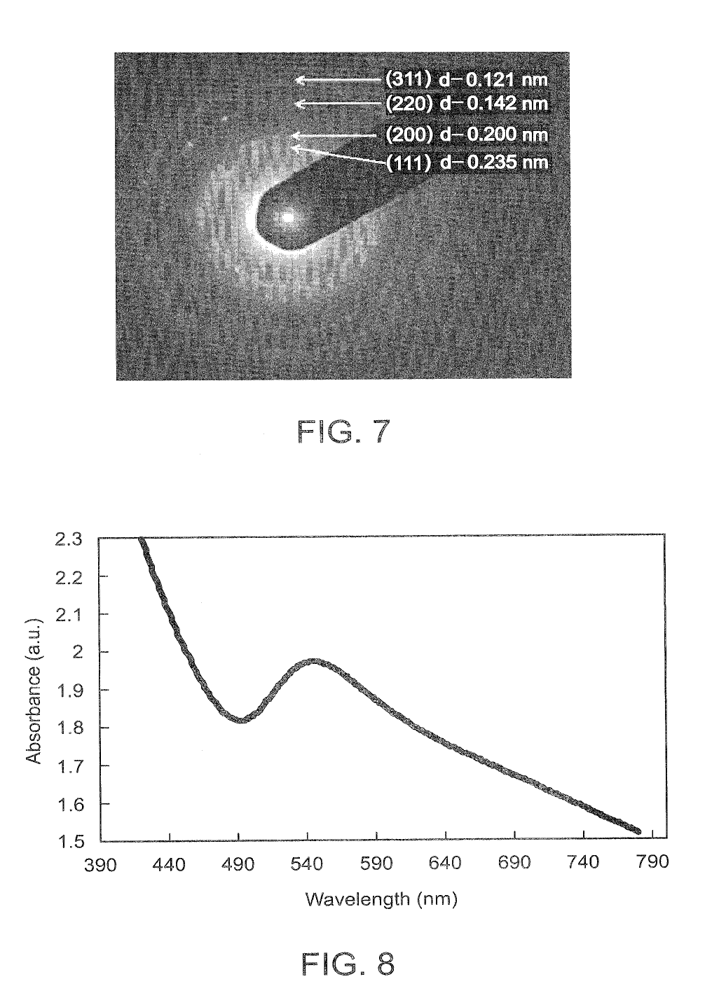

FIG. 7 is a photograph of diffraction light of the nanoparticle dispersion ion gel using a transmission electron microscope according to this embodiment. Further, FIG. 7 is an electron beam diffraction pattern of the nanoparticle dispersion ion gel, and also from this diffraction pattern, it is found that a crystal of the gold nanoparticle in the ion gel has the same fcc structure as a bulk crystal.

FIG. 8 is a view of an optical absorption spectrum of the nanoparticle dispersion ion gel according to this embodiment. In FIG. 8, the measurement result of the optical absorption spectrum of the above-produced nanoparticle dispersion ion gel is shown. At around 540 nm, a peak attributed to the surface plasmon of the gold nanoparticles can be observed. This measurement result coincides with the fact that many of the produced gold nanoparticles have a particle diameter of about 25 nm.

From the observation result using the transmission electron microscope and the measurement result of the optical absorption spectrum, it was confirmed that by subjecting an ion gel to sputtering using a gold plate as a target (nanoparticle precursor), a nanoparticle dispersion ion gel having gold nanoparticles is produced.

### Second Embodiment of Dispersion of Nanoparticles in Ion Gel

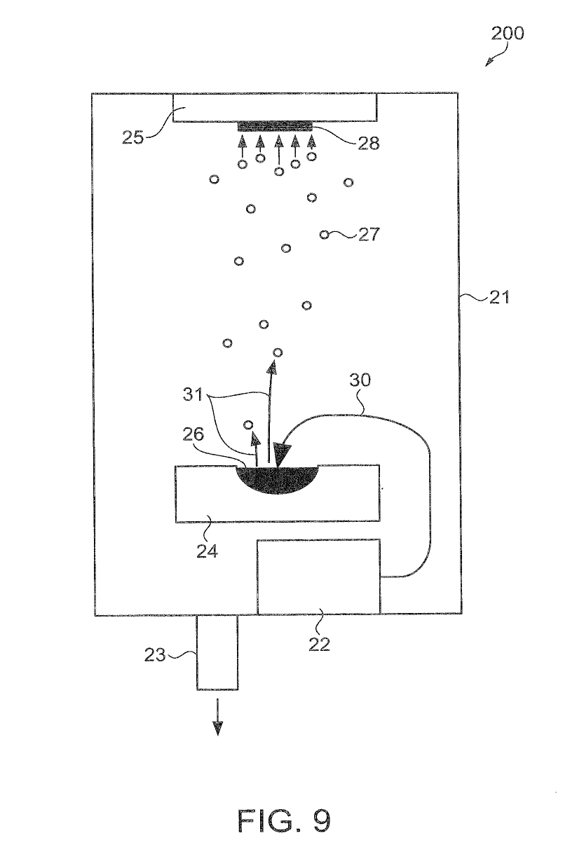

FIG. 9 is an imaginary view when a resistance heating vapor deposition apparatus according to this embodiment is used. This embodiment is an example of a case where an electron beam heating vapor deposition apparatus 200 is used in the step of dispersing nanoparticles in an ion gel. FIG. 9 shows an imaginary view of this embodiment. Incidentally, the ion gel in this embodiment is the same as in the first embodiment, and also, this embodiment is the same as the first embodiment in the point that gold is used as the nanoparticle precursor.

The electron beam heating vapor deposition apparatus 200 has a sample treatment chamber 21, and in the sample treatment chamber 21, an electron beam discharging section 22, an evaporation source retaining section 24, and a sample holding platform 25 are disposed. The evaporation source retaining section 24 has a recess and an evaporation source (gold) 26 (nanoparticle precursor) is retained in the recess. The electron beam discharging section 22 is disposed below the evaporation source retaining section 24 so that the particles ejected from the evaporation source (gold) 26 do not deposit thereto. Further, the platform 25 is disposed above the evaporation source retaining section 24, and an ion gel 28 is held to face the evaporation source retaining section 24. Incidentally, in order to reduce pressure in the sample treatment chamber 21, an exhaust pipe 23 is connected to a vacuum pump (not shown).

The discharge of an electron beam in the electron beam discharging section 22 is performed through heating by passing a current through a hot filament. The discharged electron beam is accelerated by a high voltage of about 4 to 10 kV, and converged by a magnetic field, and then output as an electron beam 30 which is the output from the electron beam discharging section 22. The electron beam 30 output from the electron beam discharging section 22 is polarized by applying a magnetic field thereto and irradiated onto the evaporation source (gold) 26.

The temperature of the evaporation source (gold) 26 irradiated with the electron beam 30 becomes locally high and the evaporation source is evaporated (the arrows 31 in FIG. 9). The evaporated evaporation source (gold) 27 penetrates into the ion gel 28 to form gold nanoparticles, whereby a nanoparticle dispersion ion gel can be produced.

### Third Embodiment of Dispersion of Nanoparticles in Ion Gel

This embodiment is an example of a case where a resistance heating vapor deposition apparatus is used in the step of dispersing nanoparticles in anion gel. When briefly describing the resistance heating vapor deposition apparatus (not shown) with reference to FIG. 9, the resistance heating vapor deposition apparatus is a vapor deposition apparatus of a type in which the electron beam discharging section 22 is removed and by heating the platform 25, the evaporation source is heated and evaporated. By using gold as the evaporation source and setting an ion gel as the vapor deposition object, a gold nanoparticle dispersion ion gel can be produced.

Hereinabove, two embodiments according to the invention are described, however, the nanoparticles dispersed and retained in the nanoparticle dispersion ion gel are not subjected to surface modification for inhibiting the activity of the nanoparticles. Due to this, the nanoparticle dispersion ion gel can be used for storing the nanoparticles, and it is possible to handle the nanoparticle dispersion ion gel as a solid. Therefore, the storage and transportation of the nanoparticle dispersion ion gel itself can be also facilitated. Further, the nanoparticles dispersed in the nanoparticle dispersion ion gel behave in a manner characteristic of the nanoparticles, and therefore, it is possible to use the nanoparticle dispersion ion gel as such in a variety of apparatuses such as sensors. The nanoparticle dispersion ion gel can simplify the handling of the nanoparticles to a large extent.

In the above-described embodiments, EMIBF₄ was used as the ionic liquid, however, the ionic liquid may be hydrophilic or hydrophobic as long as it can be adapted to the invention, and there is no particular restriction on the type thereof. For example, as the usable ionic liquid, an aliphatic ionic liquid, an imidazolium-based ionic liquid, a pyridinium-based ionic liquid, or the like can be used.

Further, the nanoparticle precursor may be a pure substance or a mixture. The pure substance may be a simple substance or a compound. There is no restriction also on the type of the nanoparticle precursor. In addition, since the ion gel can be handled as a solid, the handling thereof in the vapor deposition apparatus is easy.

### Isolation of Metal Nanoparticles

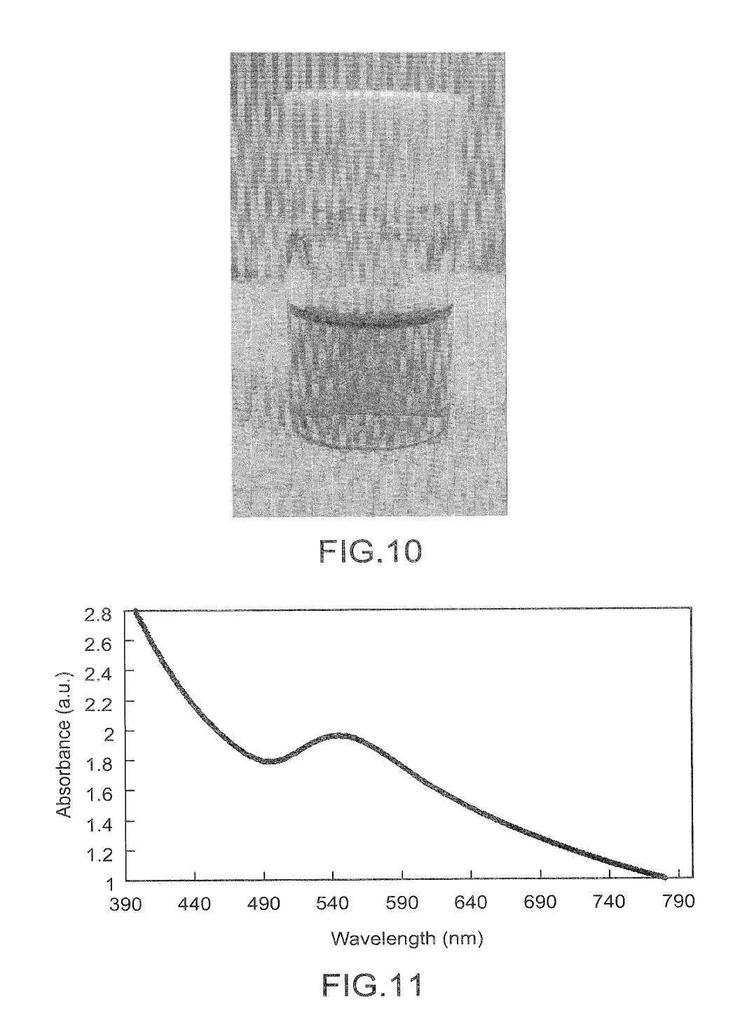

FIG. 10 is a photograph of a solution in which the nanoparticle dispersion ion gel according to this embodiment is dissolved or dispersed, and FIG. 11 is a view of an optical absorption spectrum of a solution in which the nanoparticle dispersion ion gel according to this embodiment is dissolved or dispersed.

200 mg of the ion gel containing gold nanoparticles produced in the above-described second embodiment or third embodiment is dissolved in a mixed liquid containing 2 ml of the organic solvent (1) and 2 ml of the organic solvent (2), and the resulting mixed liquid is stirred by sonication for 1 hour and then stirred by a stirrer at 80° C. for 5 hours. A photograph of the solution in which the nanoparticle dispersion ion gel is dissolved or dispersed is shown in FIG. 10. Further, the measurement result of the optical absorption spectrum of this solution is shown in FIG. 11. In the same manner as the absorption spectrum of the ion gel shown in FIG. 8, at around 540 nm, a peak attributed to the surface plasmon of the gold nanoparticles can be observed. This result shows that by the dissolution and stirring treatments of the nanoparticle dispersion ion gel, the nanoparticles are dispersed in the solution while keeping the particle diameter thereof. By centrifuging this solution with a centrifuge (KUBOTA's micro centrifuge M-4200CE) at a rotation speed of 4500 rpm for 30 minutes, the gold nanoparticles in the liquid phase was precipitated.

The invention is not limited to the above-described contents and can be applied widely within a scope that does not deviate from the gist of the invention.

The method for producing nanoparticles according to the invention can be used for producing materials such as highly active photocatalysts, optoelectronic elements, and biomolecular markers.

The entire disclosure of Japanese Patent Application No. 2011-106982, filed May 12, 2011 is expressly incorporated by reference herein.

What is claimed is:

1. A method for producing nanoparticles comprising:
producing a nanoparticle dispersion ion gel in which a plurality of nanoparticles are dispersed; and
dissolving the nanoparticle dispersion ion gel, thereby producing a liquid in which the plurality of nanoparticles are dispersed.

2. The method for producing nanoparticles according to claim 1, further comprising centrifuging the liquid in which the plurality of nanoparticles are dispersed.

3. The method for producing nanoparticles according to claim 1, wherein the producing a nanoparticle dispersion ion gel includes evaporating an evaporation source containing an element contained in the nanoparticles toward an ion gel under reduced pressure in a vapor deposition apparatus.

4. The method for producing nanoparticles according to claim 1, wherein the producing a nanoparticle dispersion ion gel includes:
stirring a mixed liquid containing an ionic liquid and a gelling agent to produce a stirred mixed liquid; and
drying the stirred mixed liquid.
